(19) United States
(12) Patent Application Publication
(10) Pub. No.: US 2022/0271987 A1
(43) Pub. Date: Aug. 25, 2022

(54) METHODS AND SYSTEM FOR ADAPTIVE MEASUREMENTS APPLIED TO REAL TIME PERFORMANCE MONITORING IN A PACKET NETWORK

(71) Applicant: Cheetah Networks, Ottawa (CA)

(72) Inventors: Michael Joseph McCallen, Ottawa (CA); David Victor Hudson, Ottawa (CA)

(21) Appl. No.: 17/631,232

(22) PCT Filed: Jun. 19, 2020
(86) PCT No.: PCT/CA2020/050853

§ 371 Date: Jan. 28, 2022

Related U.S. Application Data
(60) Provisional application No. 62/883,730, filed on Aug. 7, 2019.

(51) Int. Cl. H04L 41/046; H04L 43/16; H04L 41/147; H04L 41/0681; H04L 43/04

(52) U.S. Cl. CPC H04L 41/046; H04L 43/16; H04L 41/147; H04L 41/0681; H04L 43/04

(57) ABSTRACT

The present invention relates to methods and system for adaptive measurements applied to real time performance monitoring in a packet network. In particular, the present invention provides a method of real-time performance monitoring of a packet network by measuring by an agent of at least one performance metric. Measurement methodology can be adjusted in response to said at least one performance metric.

### FIELD OF THE INVENTION

This invention pertains generally to networks and, more particularly methods and system for adaptive measurements applied to real time performance monitoring in a packet network.

### BACKGROUND OF THE INVENTION

Performance monitoring (PM) is used in packet networks to ensure that digital services are delivered at a committed and/or acceptable level of quality. There exist many methods for PM in use today. The majority of these extant methods were derived from Time Domain Multiplexing (TDM), and are utilized for monitoring of Ethernet Virtual Circuits (EVC) and assume a predictable and consistent traffic pattern from end to end across the network. As an example, in TDM-derived approaches, the gathering and reporting of statistics is performed every 5 or 15 minutes and the statistics include minimum, maximum and average latency. Such sample-based statistics are useful in a TDM network where capacity is pre-allocated to EVCs, but provide little useful information for networks based on the Internet Protocol (IP). IP networks do not pre-allocate capacity end-to-end and are subject to dynamic bursting where traffic levels can rise and fall at multiple, disparate points in the network from end to end. Simple sampling approaches to PM are inadequate in a packet network such as an all IP network

Moreover, the introduction of Software Defined Networking (SDN), Network Function Virtualization (NFV), fifth generation wireless (5G) and Internet of Things (IoT) will further reduce the value of simple sampling approaches to PM. SDN, NFV and 5G increase the virtualization of networks which means that the functions needed to move packets from end to end are implemented on shared processors. The sharing extends to multiple network functions consuming resources on one processor and multiple network operators sharing the network links and processors. Virtual functions are assigned to the available processors across the network dynamically based on a variety of factors. In addition, 5G and IoT dramatically increase the number and diversity of end points on networks where those end points may send very low to very high volumes of traffic, may need very high to very low performance and consistency of performance and may regularly send traffic or rarely send traffic. These end points may be simple sensors that always send the same sort of traffic or sophisticated personal devices whose traffic need change with the application in use.

Current PM methods are ineffective in packet-based networks with emerging SDN, NFV, 5G, IoT and other capabilities that add even higher levels of sharing of resources to deliver traffic with highly variable characteristics. For example, in current PM methods the minimum sampled latency of a service could be close to zero while the maximum latency could be close to maximum provisioned rate of the network link at any time. The average latency does not accurately capture what may have happened in the 5 or 15 minutes between samples for a packet-based network. In a packet network at any instant (e.g. millisecond, second) the traffic profile is different and the measurements of metrics like latency fluctuate. Users of a mobile device experience this first hand many times in their everyday usage. Furthermore, when a latency or throughput issue arises, determining the cause with a simple, coarse sample is difficult as the root cause may be in any link or processor between the end points of the service. Was it the mobile device's CPU? Was it the connection speed? Was it network congestion? Was it congestion on the servers in the cloud? Coarsely sampled statistics showing minimums, maximums and averages provide very rudimentary PM insight.

Currently deployed PM systems use a fixed packet rate and packet size for sampling. The packet size selection is intended to emulate that of the service being monitored and the packet rate is determined by the network operator with a goal of minimizing the use of overhead bandwidth at the expense of customer payload. The network operator typically selects a low sampling rate (for example, 1 packet/second).

There are extant approaches where more granular measurements are taken for specialized services, for example, like high frequency trading. This is not sufficient as such approaches requires engineering of the PM application itself. Typically, a standards-based solution like Y.1731 or TWAMP, requires a complex configuration of the two ends being monitored. The network operator needs to define a packet size, how often to send test packets, what markings, etc. This frustrates operators who have invested much to engineer their services and now need to engineer the PM applications. It also blocks automation which is an important tool for the operators since current systems requires manual configuration of fixed parameters adding complexity and cost to not just the initial install but any subsequent service changes like increasing the customer data rate.

Exemplary prior art methods and systems are described in U.S. Pat. No. 7,430,179-B2, EP-2883333-61, U.S. Ser. No. 10/122,651-B2, U.S. Pat. No. 9,787,559-B1 and U.S. Pat. No. 6,366,563-B1.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide methods and systems for adaptive PM measurements applied to real time performance monitoring in any type of packet network.

In accordance with an aspect of the invention, there is provided a method of real-time performance monitoring of a packet network, said method comprising (i) measuring, in real-time, by one or more agent(s) installed at one or more points on a network, at least one performance metric; (ii) analyzing, in real-time, by said one or more agent(s) said at least one performance metric to determine performance; and (iii) automatically adjusting measurement methodology of at least one of said one or more agent(s) for future measurements and/or adjusting measurement methodology of one or more downstream agent(s) in response to said at least one performance metric.

In accordance with another aspect of the present invention, there is provided a method of real-time performance monitoring of a packet network, said method comprising a). providing a plurality of agents, wherein each of said plurality of agents is installed at any point or points on said network where data packets are processed; b.) sending, by a first agent installed at a first point on said network, a data packet to a second agent installed at a second point on said network; c) receiving, by said second agent, said data packet; d) measuring by said first agent and/or second agent, in real-time, at least one performance metric of packet traffic of said data packet between said first and second point; e) analyzing by said first agent and/or second agent, in real-time, said at least one performance metric to determine performance of said network predict at least one future performance metric based on said at least one performance metric; and optionally triggering an alert if at least one performance metric is predicted to exceed a pre-defined threshold in the future; and f) automatically adjusting measurement methodology of at least one of said one or more agent(s) for future measurements and/or adjusting measurement methodology of one or more downstream agent(s) in response to said at least one performance metric.

In accordance with another aspect of the invention, there is provided a method of real-time performance monitoring of a packet network, said method comprising a) providing a plurality of agents, wherein each of said plurality of agents is installed at a point on said network where data packets are processed; b) sending, by a first agent installed at a first point on said network, a first data packet to a second agent installed at a second point on said network; c) receiving, by said second agent, said first data packet; d) sending from said second agent a second packet to said first agent; e) receiving, by said first agent, said second data packet; f) measuring by said first agent and/or second agent, in real-time, at least one performance metric of packet traffic of said first data packet and/or said second data packet between said first and second point; g) analyzing by said first agent and/or second agent, in real-time, said at least one performance metric to determine performance of said network and predict at least one future performance metric based on said at least one performance metric; and optionally triggering an alert if said at least one future performance metric is predicted to exceed a pre-defined threshold; and h) automatically adjusting measurement methodology of at least one of said one or more agent(s) for future measurements and/or adjusting measurement methodology of one or more downstream agent(s) in response to said at least one performance metric.

In certain embodiments, the at least one performance metric is selected from the group consisting of latency, jitter, loss and out of sequence.

Agents may provide monitoring for any type of service in any type packet-based network. In certain embodiments, the method monitors network services selected from voice network service, video network service and data network service. In other embodiments, the method monitors services from dedicated or cloud servers. Packet network types include but are not limited to radio access, aggregation, core, data center and enterprise networks.

### BRIEF DESCRIPTION OF THE DRAWINGS

These and other features of the invention will become more apparent in the following detailed description in which reference is made to the appended drawings.

FIG. 1 illustrates customer payload traffic and synthetic traffic in a network moving between Point A and B. Points A and B can be anywhere in the network where packets are processed (for example, router or switching point). Agents are installed at Point A and Point B. Agent at Point A generates synthetic traffic comprising packets directed towards the Agent at Point B. At Pont B, the Agent receives each packet, modifies and creates a return packet and sends the return packet back to Agent at Point B. The network in between which is comprised of many elements actually takes care of transporting the packet itself. The agents simply follow the rules of the network (e.g. Layer 3 requires destination and source IP addresses). The Agent at Point A receives the return packet and makes measurements such as latency and loss using timestamps and sequence numbers provided by the packet. The Agent will track the measurements over time to enable effective reporting to a management system.

FIG. 2 illustrates customer payload and synthetic packet traffic between Agents at Points A and B. FIG. 2 also shows the use of are dynamic measurement storage. In some embodiments, Agents at Points A and B are making measurements and have standard storage (for example, to retain 5 minute averages). In other embodiments, the Agents are enhanced to include in the moment metrics including last second minimums, maximums, and averages. All these metrics are time based to allow for in the moment comparisons. Optionally, agents can share dynamic measurement data with one another. Shared storage is important when paths vary due the changing network, for intermediate points in a path, and also for different adjacencies (i.e. where Agent have different network connection points).

FIG. 3 illustrates the adaptive response of the analytics of the system. Analytics algorithm(s) analyze in real-time (for example, in micro-seconds) the in the moment metrics, and assess if the performance of the network service is improving or degrading. If performance is improving the algorithm may adjust, for example, the sampling rate upwards to improve the measurement granularity or accuracy. Hypothetically the algorithm could increase sampling to consume the total bandwidth of the network service to stress test a network service during a maintenance window. If the analytics determines the network service is degrading then, for example, the sampling rate could be reduced to maintain measurement of the service but minimize the impact of PM. Sampling could be reduced all the way to zero. This adaptive capability eliminates the need to manually provision a fixed PM rate and fixed PM packet size, as the analytics algorithm will automatically adjust these parameters. The network operator can provide upper and lower limits to set an envelope for the measurement adapter to work within.

FIG. 4 illustrates basic payload measurement. Measurement, analytics and adaptation occurs between agents at Points A and B.

FIG. 5 illustrates embodiments where agents are deployed at multiple locations.

### DETAILED DESCRIPTION OF THE INVENTION

Various methods and systems for real time performance monitoring of a packet network are described including adaptive or responsive performance monitoring. The adaptive or responsive configuration of the performance monitoring is applicable to any packet network performance monitoring use case. The methods and systems described herein are configurable and/or scalable to monitor performance of the full network, a portion of the network, services or sessions. The methods and systems are configured to assess performance metrics in a very short window of time (for example micro-seconds) and provide almost immediate feedback to allow for adjustment of monitoring protocols. Performance metrics assessed by the methods and systems of the present invention include but are not limited to latency, latency fluctuations or jitter, packet loss, out of sequence and error rate.

In certain embodiments, the performance monitoring of the present invention operates independent of the service or services provided by the network. The methods of the present invention may be used to monitor various network services including but not limited to voice network service, video network service and data network service. In certain embodiments, the performance monitoring of the present invention operates independent of the type of network being monitored. Non-limiting exemplary networks include but is not limited to radio access, core, data center and enterprise.

In some embodiments, the methods and systems utilize synthetic traffic to generate performance measurements. Synthetic traffic is generated by agents deployed in the network and comprise one or more synthetic data packets. The synthetic traffic is generally configured to travel a similar path in the network as payload traffic and includes fields like source and destination IP addresses, source and destination MAC addresses priority, QoS markings, port numbers, etc. It may also include information like timestamps and other non header fields.

In alternative embodiments, passive measurements of actual payload traffic are used instead of performance measurements of synthetic traffic and are inputted into the analytics and traffic adapter algorithms. Optionally, a combination of measurements from synthetic and actual traffic are employed wherein passive monitoring measurements of actual payload traffic is inputted as well to the synthetic measurement adaption algorithms.

In embodiments that use passive measurements of actual payload traffic, actual payload traffic is not modified. Rather Agent B sends a summary report to Agent A or to a monitoring element periodically with a summary of traffic including for example number of packets received, average latency per packet. Optionally in such embodiments, agents at Point A and Point B message directly. Direct messages between agents include information about the payload traffic being monitored.

Agents implement the performance monitoring. The performance measurement method being adjustable using an adaptation technique based on analytics and machine learning techniques that are used to learn the behavior of the monitored network and the effect of changing network performance on the services. Exemplary machine learning methods includes but is not limited to SVM, Naive based, Decision tree and Random forest. The system and method comprise at least two agent and preferably a plurality of agents. The methods and system is scalable and can deploy more agents. The agents are located generally where packets are processed (for example router or switching point), at every hop in a network, edge device or at end points.

Agents are configured to 1) create and send synthetic data packets, 2) receive and analyze synthetic data packets, 3) passive data analysis of actual traffic or a combination of all three. Agents analyzing synthetic data packets and traffic avoids having to send large volumes of data to a central PM processor.

A dynamic rate adapter removes the requirement for the operator to pre-configure a packet sampling rate as well as enables an analytics or machine learning process to automatically determine and adjust performance measurements by varying, for example, the packet size and rate. Automatically adapting the PM measurements using analytics removes the current requirement for pre-configuration of PM and allows for improvements in PM capabilities.

The invention can be further described with reference to the figures.

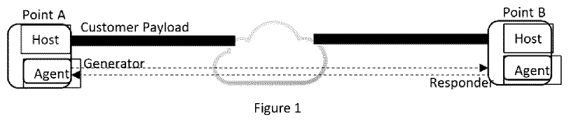

Referring to FIG. 1, customer payload traffic moves between Point A and Point B in the network. Points A and B can be anywhere in the network where packets are processed (for example, router or switching point) or at end points. Agents are installed at Point A and Point B. The Agent at Point A creates synthetic traffic (dotted line) towards the Agent at Point B. The Point B Agent receives the synthetic packet, creates a return packet (dotted line) and sends that return packet back to the Agent at Point A. In some embodiments, receipt and analysis of the return packet by Agent A triggers an adjustment in measurement methodology by Agent A, for example, the adjustment can include a change in the frequency or size of the synthetic packets.

The network in between, represented by the cloud icon, is comprised of many elements and takes care of transporting the packet itself. The Agents simply follow the rules of the network in creating their synthetic traffic (e.g. Layer 3 requires destination and source IP addresses).

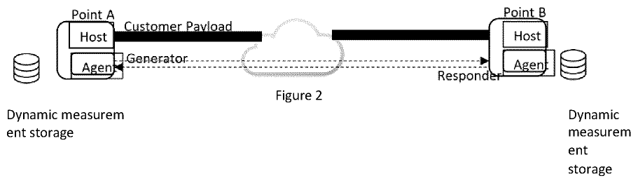

Referring to FIG. 2, Agent A makes measurements such as latency and loss using timestamps and sequence numbers and stores the measurements in dynamic measurement storage. For example, latency can be determined by tracking the initial time of the packet and the time received and subtracting the two will provide the latency for that packet. Optionally, the measurements are stored locally to facilitate analytics. Agent A track these measurements over time to enable effective performance reporting to a management system. In some embodiments, measurements are taken at pre-set intervals, for example, every 5 minutes

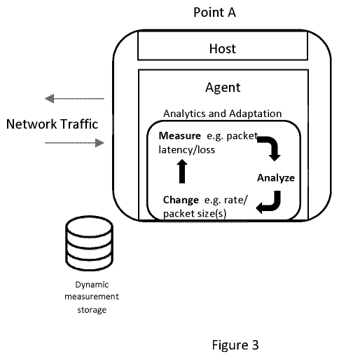

Referring to FIG. 3, the Agents take performance measurements and have standard storage for measurement data (for example, 5 minutes averages). The agents include in the moment metrics, as an example, performance measurements for the most recent second or minute, the maximum over the last 5 minutes and the average over the last 5 minutes. All of the stored metrics are time based to allow for in the moment comparisons over time at one Agent or between Agents.

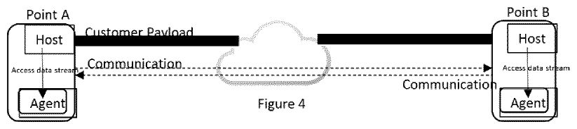

Referring to FIG. 4, Agents at Point A and Point B gain access to packets as they are sent and received and create measurements based on the payload traffic itself. This requires that the host provide access to packets via a filtering method or port-forwarding method. This could be achieved on the actual host or a more central point the network and historically accomplished using high-performance probes that have taps into the network traffic. Agent A will create measurements such as latency and loss using timestamps and sequence numbers of the payload traffic, which maybe sample based (e.g. every 100th packet). Agent will track them over time to enable effective reporting to a management system (for example every 5 minutes).

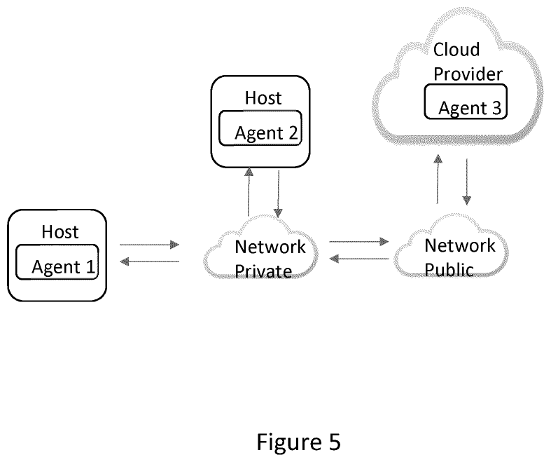

Referring to FIG. 5, in certain embodiments, agents are deployed at multiple locations. Services are increasingly implemented in virtualized environments using SDN, NFV and cloud technologies. With 5G and IOT, virtualization includes network elements that are near the edge or access portion of the network (that is, close to the user) as well as network elements in the core of the network. Agents can provide monitoring for any type of service in any packet based network. Agents may be placed, for example on personal computers, physical servers, smartphones, virtual servers, network elements, sensors and the like. Agents may also be placed in networks that include public network elements (such as those operated by an Internet service provider) and private network elements (such as those operated by a company with its own internal network).

Analytics algorithms in the Agents analyze in real-time (e.g. micro-seconds) the in the moment performance metrics. In some embodiments, analytics assess, for example, if the performance of the network service is improving or degrading based on the performance metrics.

In some embodiments, agents share performance measurement data with one another. Consequently, analytics can consider performance at a point in the network, performance over time, or performance between points in the network. This allows, for example, comparison of the performance of diverse paths through the network that arise due to physical network topology or routing changes in the network that occur under traffic load or varying traffic characteristics, assessment of the performance at intermediate points in an end to end service and for measurement of different adjacencies (i.e. different agent connections). Consequently, in some embodiments, agents can correlate measurements over time, between different performance metrics, between different network locations and between different services. Agents also allow for distributed collection and processing of PM data, eliminating the need to send large volumes of data to a central location for processing and storage. A central function is included in some embodiments to receive summarized or meta-data from the agents and to provide agents with analytics parameters.

In certain embodiments, agents automatically adjust how performance is measured based on the results of the analytics. If, for example, an Agent determines that network performance is improving and/or is stable, the Agent optionally adjusts the performance sampling rate down to reduce the bandwidth consumed. If, for example, an Agent determines that network performance is decreasing, the Agent optionally adjusts the performance sampling rate up. Similarly, if the Agent, for examples, determines that network performance is highly variable, the Agent increases the sampling interval to improve the performance measurement accuracy. In some embodiments, the system and methods increase network performance measurements to consume most of or the total bandwidth of the network service thereby enabling an ability to also periodically perform a wire rate test of the service. Optionally, wire rate tests are performed at set intervals, optionally at periods of low traffic or predicted low traffic.

In some embodiments, network performance testing intervals is in part base on traffic or predicted traffic. Accordingly, if the Agent determines the network service is significantly congested then, for example, the sampling rate could be reduced to zero to eliminate bandwidth use be performance management.

The automation based on the analytics in the system and method eliminates the need to manually provision a fixed rate and fixed packet size, as the analytics algorithm will automatically adjust performance measurement. In some embodiments, network operators can provide upper and lower thresholds to set an envelope for performance measurement automation.

In some embodiments, the system and methods are configured to allow for auto-calibration. In such embodiments, machine learning is utilized to learn a baseline (for example, no customer traffic present) and set that as the calibrated values to compare future measurements to.

Calibration of the network using the methods of the invention can be completed at initial deployment and optionally periodically to capture changes in baseline.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A method of adaptive real-time performance monitoring of a packet network, said method comprising:
(i) measuring, in real-time, by one or more agent(s) installed at one or more points on a network, at least one performance metric to determine performance; and
(ii) automatically adjusting measurement methodology of at least one of said one or more agent(s) for future measurements and/or adjusting measurement methodology of one or more downstream agent(s) in response to said at least one performance metric.

2. The method of claim 1, wherein said method monitors traffic of data packets on a network or portion of a network and wherein optionally the one or more data packets are synthetic data packets.

3. The method of claim 1, further comprising predicting at least one future performance metric based on said at least one performance metric; and optionally triggering an alert if said at least one performance metric is predicted to exceed a pre-defined threshold or is outside predefined range in the future.

4. A method of real-time performance monitoring of a packet network, said method comprising:
a. providing a plurality of agents, wherein each of said plurality of agents is installed at any point on said network where data packets are processed;
b. sending, by a first agent installed at a first point on said network, a data packet to a second agent installed at a second point on said network;
c. receiving, by said second agent, said data packet;
d. measuring by said first agent and/or second agent, in real-time, at least one performance metric of packet traffic of said data packet between said first and second point;
e. analyzing by said first agent and/or second agent, in real-time, said at least one performance metric to determine performance of said network predict at least one future performance metric based on said at least one performance metric; and optionally triggering an alert if said at least one performance metric is predicted to exceed a pre-defined threshold in the future; and
f. automatically adjusting measurement methodology of at least one of one or more agent(s) for future measurements and/or adjusting measurement methodology of one or more downstream agent(s) in response to said at least one performance metric.

5. A method of real-time performance monitoring of a packet network, said method comprising:
a. providing a plurality of agents, wherein each of said plurality of agents is installed at a point on said network where data packets are processed;
b. sending, by a first agent installed at a first point on said network, a data packet to a second agent installed at a second point on said network;
c. receiving, by said second agent, said first data packet;
d. sending from said second agent a second packet to said first agent;
e. receiving, by said first agent, said second data packet;
f. measuring by said first agent and/or second part, in real-time, at least one performance metric of packet traffic of said first data packet and/or said second data packet between said first and second point;
g. analyzing by said first agent and/or second agent, in real-time, said at least one performance metric to determine performance of said network and predict at least one future performance metric based on said at least one performance metric; and optionally triggering an alert if said at least one performance metric is predicted to exceed a pre-defined threshold in the future;
h. automatically adjusting measurement methodology of at least one of said one or more agent(s) for future measurements and/or adjusting measurement methodology of one or more downstream agent(s) in response to said at least one performance metric; and
i. handling performance measurement processing within the agents to minimize large volumes of data being sent to a central location for processing; summarized results or meta-data may be sent to a central location.

6. The method of claim 1, wherein said one or more agents comprise storage for said at least one performance metric.

7. The method of claim 1, wherein said at least one performance metric is selected from the group consisting of latency, jitter, loss and out of sequence.

8. The method of claim 1, wherein said method monitors network services selected from voice network service, video network service and data network service.

9. The method of claim 1, wherein said monitoring is independent of the service or services provided by the network.

10. The method of claim 9, wherein the network is radio access, core, data center, enterprise, and so on.

11. The method of claim 1 further comprising agent(s) automatically comparing said at least one performance metric with a comparable metric obtained from agents installed at other points on said network and automatically adjusting measuring methodology based on results of comparison.

12. The method of claim 1 further comprising agent(s) automatically correlating performance metrics over time, between agents at different network locations and between agents measuring different services.

13. The method of claim 4, wherein said one or more agents comprise storage for said at least one performance metric.

14. The method of claim 5, wherein said one or more agents comprise storage for said at least one performance metric.

15. The method of claim 4, wherein said at least one performance metric is selected from the group consisting of latency, jitter, loss and out of sequence.

16. The method of claim 5, wherein said at least one performance metric is selected from the group consisting of latency, jitter, loss and out of sequence.

17. The method of claim 4, wherein said method monitors network services selected from voice network service, video network service and data network service.

18. The method of claim 5, wherein said method monitors network services selected from voice network service, video network service and data network service.

19. The method of claim 4, wherein said monitoring is independent of the service or services provided by the network.

20. The method of claim 5, wherein said monitoring is independent of the service or services provided by the network.

21. The method of claim 19, wherein the network is radio access, core, data center, enterprise, and so on.

22. The method of claim 20, wherein the network is radio access, core, data center, enterprise, and so on.

23. The method of claim 4 further comprising agent(s) automatically comparing said at least one performance metric with a comparable metric obtained from agents installed at other points on said network and automatically adjusting measuring methodology based on results of comparison.

24. The method of claim 5 further comprising agent(s) automatically comparing said at least one performance metric with a comparable metric obtained from agents installed at other points on said network and automatically adjusting measuring methodology based on results of comparison.

25. The method of claim 4 further comprising agent(s) automatically correlating performance metrics over time, between agents at different network locations and between agents measuring different services.

26. The method of claim 5 further comprising agent(s) automatically correlating performance metrics over time, between agents at different network locations and between agents measuring different services.
